(19) United States
(12) Patent Application Publication
(10) Pub. No.: US 2015/0204969 A1
(43) Pub. Date: Jul. 23, 2015

(54) TARGET SPOTTING AND TRACKING APPARATUS AND METHOD

(71) Applicant: SpotterRF LLC, Orem, UT (US)

(72) Inventors: Logan Carl Harris, Orem, UT (US); Benjamin Walter Dilsaver, Provo, UT (US); Derek Gordon Nielson, Lehi, UT (US); Benjamin Farris Bush, Provo, UT (US)

(73) Assignee: SpotterRF LLC, Orem, UT (US)

(21) Appl. No.: 14/158,459

(22) Filed: Jan. 17, 2014

(51) Int. Cl. G01S 7/41; G01S 13/06

(52) U.S. Cl. CPC G01S 7/41; G01S 13/06

(57) ABSTRACT

A method for determining location information for a target may include generating a cyclic transmit signal having a fixed frequency slope over a substantial portion of each cycle and an operational frequency that is selected to penetrate foliage, transmitting the cyclic transmit signal without up-conversion with at least one transmit antenna, down-converting two or more return signals received from corresponding return antennas with the cyclic transmit signal to provide a corresponding set of baseband signals, extracting magnitude and phase information for each return signal as a function of range from the plurality of baseband signals, and determining a location of a target from the magnitude and phase information. A corresponding apparatus, system, and computer readable medium are also disclosed herein.

### BACKGROUND OF THE INVENTION

1. Field of the Invention

This invention relates to security systems in general and to radar based security systems in particular.

2. Description of the Related Art

The ability to spot and track targets is an important aspect of providing security for commercial buildings, public buildings, government facilities, power generation and water treatment plants, transportation hubs, border positions, and the like. As depicted in FIG. 1, decorative and/or functional foliage is often present in such environments particularly when green-energy buildings are involved. However, such foliage may reduce or block the ability of security personal to visually spot and track personnel, visitors, and vehicles via direct observation or security cameras. Consequently, what is needed are means and methods to spot and track targets in foliage-present environments.

### SUMMARY OF THE INVENTION

The present invention has been developed in response to the present state of the art, and in particular, in response to the problems and needs in the art that have not yet been fully solved by currently available security systems. Accordingly, the present invention has been developed to provide a target tracking method, apparatus, system, and computer readable medium that overcome shortcomings in the art.

A method for determining location information for a target may include generating a cyclic transmit signal having a fixed frequency slope over a substantial portion of each cycle and an operational frequency that is selected to penetrate foliage, transmitting the cyclic transmit signal without up-conversion with at least one transmit antenna, down-converting two or more return signals received from corresponding return antennas with the cyclic transmit signal to provide a corresponding set of baseband signals, extracting magnitude and phase information for each return signal as a function of range from the plurality of baseband signals, and determining a location of a target from the magnitude and phase information. A corresponding apparatus, system, and computer readable medium are also disclosed herein.

The methods described herein may be embodied as a computer program product or computer readable medium comprising computer readable program codes configured to conduct the described methods. It should also be noted that references throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a pictorial diagram illustrating one example of a target tracking environment in which at least some of the embodiments disclosed herein may be deployed;

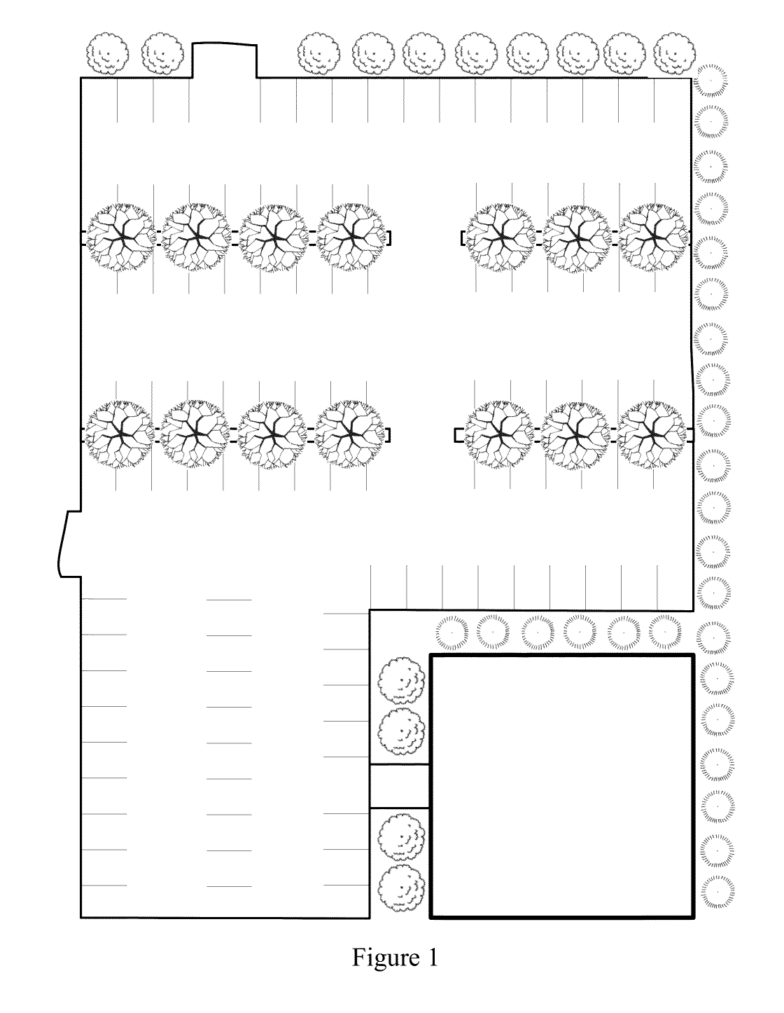

FIG. 2 is a block diagram depicting one embodiment of a target tracking apparatus;

FIG. 3 is a flowchart diagram depicting one embodiment of a target tracking method;

FIG. 4 is a flowchart diagram depicting one embodiment of a return signal processing method;

FIG. 5 is a graphical diagram depicting certain aspects of the return signal processing method of FIG. 4; and

FIG. 6 is a front view of one embodiment of a planar antenna.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

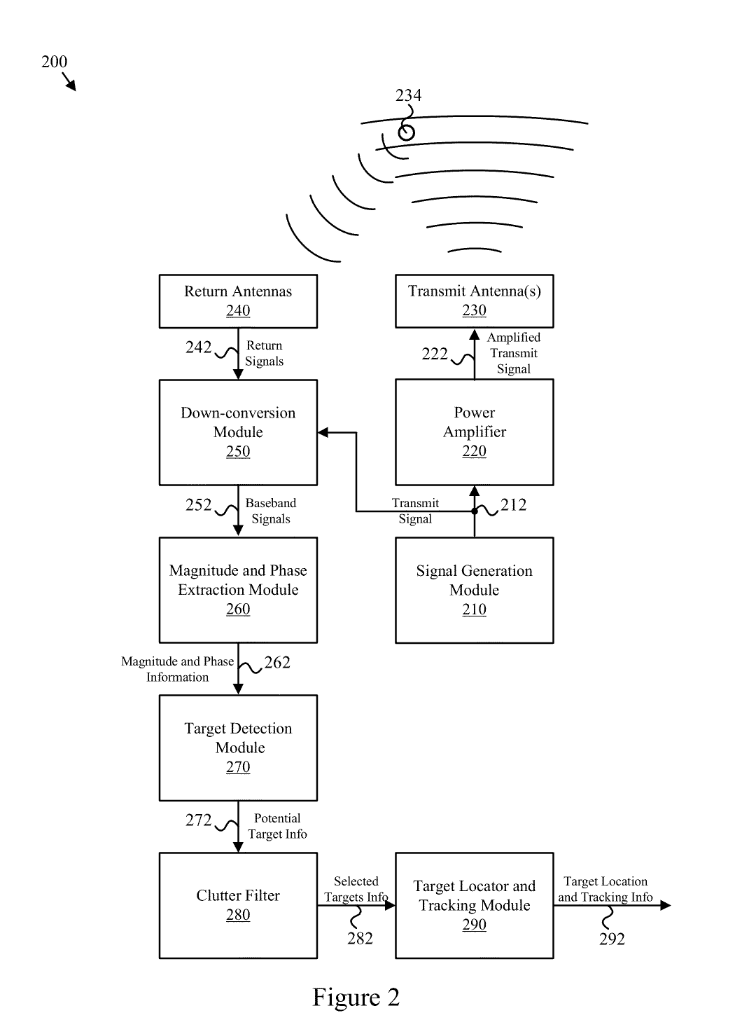

FIG. 2 is a block diagram depicting one embodiment of a target tracking apparatus 200. As depicted, the target tracking apparatus 200 includes a signal generation module 210, a power amplifier 220, one or more transmit antennas 230, two or more return antennas 240, a down-conversion module 250, a magnitude and phase extraction module 260, a target detection module 270, a clutter filter 280, and a target locator and tracking module 290. The target tracking apparatus 200 enables target tracking in foliage-present environments.

The signal generation module 210 generates a transmit signal 212. The transmit signal 212 may be a continuous directly-synthesized cyclic chirp signal whose rate of frequency change is substantially constant within a chirp cycle. In one embodiment, the rate of frequency change for the transmit signal 212 varies less than 20 milli-radians over an operating period of 5 seconds.

In certain embodiments, the transmit signal is directly synthesized by accessing a digital memory with a digital waveform stored therein and converting the digital waveform to the transform signal 212 via a digital-to-analog converter (not shown). The frequency of the digital waveform and operational frequency of the transmit signal may be selected to facilitate foliage penetration. For example, the operational frequency may be less than 1 GHz.

The power amplifier 220 amplifies the transmit signal 212 to provide the amplified transmit signal 222 to the transmit antenna(s) 230. The transmit antenna(s) 230 radiate an electro-magnetic beam corresponding to the amplified transmit signal 222.

Each return antenna 240 receives electromagnetic energy reflected by elements in the surrounding environment such as a target 234 and provides a return signal 242. The down-conversion module 250 down-converts each return signal 242 to provide a corresponding baseband signal 252. The magnitude and phase extraction module 260 extracts magnitude and phase information from each baseband signal 252 to provide magnitude and phase information 262.

The target detection module 270 processes the magnitude and phase information 262 to provide potential target information 272. The clutter filter 280 receives the potential target information 272 and provides the selected target information 282. The target location and tracking module 290 receives the selected target information 282 and provides the target location and tracking information 292. The target location and tracking information 292 may be presented to a user.

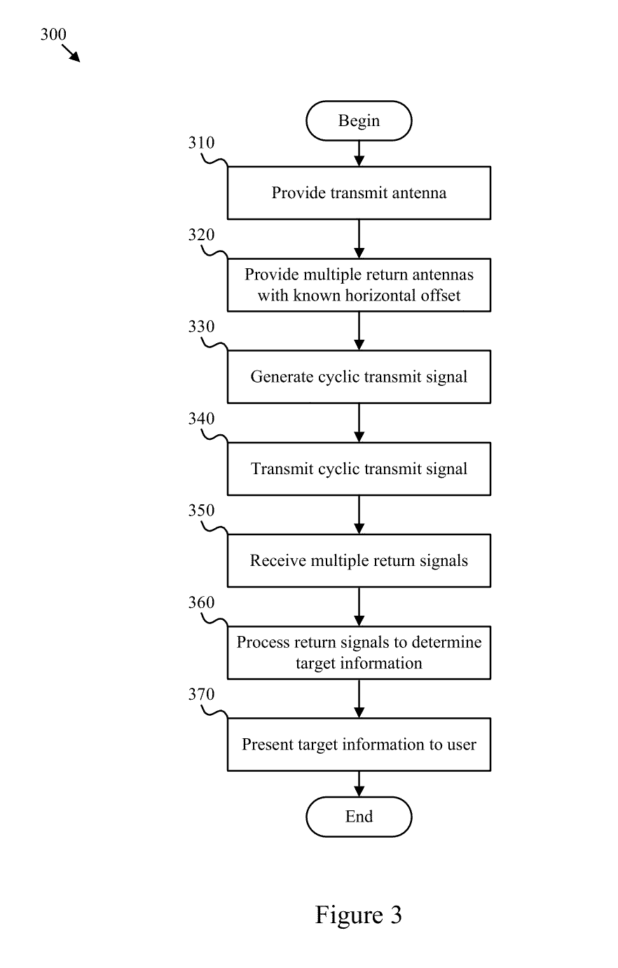

FIG. 3 is a flowchart diagram depicting one embodiment of a target tracking method 300. As depicted, the target tracking method 300 includes providing 310 a transmit antenna, providing 320 multiple return antennas, generating 330 a cyclic transmit signal, transmitting 340 the cyclic transmit signal, receiving 350 multiple return signals, processing 360 the return signals, and presenting 370 target information to a user. The target tracking method 300 may be conducted in conjunction with the target tracking apparatus 200 or the like.

Providing 310 a transmit antenna may include providing an antenna that emits a beam pattern that illuminates a portion of the horizon in a security environment. For example, the beam pattern may be relatively wide in the horizontal direction and relatively shallow in the vertical direction.

Providing 320 multiple return antennas may include providing conventional or printed circuit antennas that are offset by a known distance in order to accurately calculate the source positions of reflections captured by the return antennas.

Generating 330 a cyclic transmit signal may include generating a cyclic chirp signal. The cyclic transmit signal may have an operational frequency that is below 1 GHz in order to pass through foliage. In one embodiment, the cyclic transmit signal is a chirp signal that cycles between 902 and 928 MHz.

Transmitting 340 the cyclic transmit signal may include radiating electromagnetic energy whose amplitude corresponds to the cyclic transmit signal. Receiving 350 multiple return signals may include receiving signals provided by a set of receive antennas.

Processing 360 the return signals may include processing the signals provided by the receive antennas to determine the location of one or more targets. Presenting 370 target information to a user may include presenting information regarding the position and velocity of one or more targets.

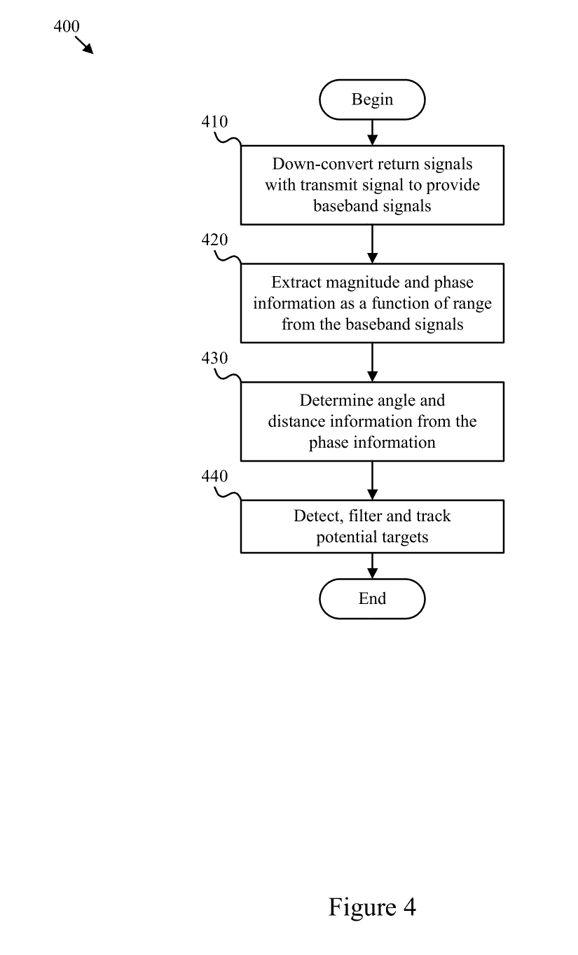

FIG. 4 is a flowchart diagram depicting one embodiment of a return signal processing method 400. As depicted, the return signal processing method 400 includes down-converting 410 one or more return signals, extracting 420 magnitude and phase information, determining 430 angle and distance information, and detecting, filtering, and tracking 440 one or more potential targets. The processing method 400 is one example of the processing operation 360 shown in FIG. 3.

Down-converting 410 one or more return signals may include demodulating the return signals with a transmit signal to provide baseband signals. Extracting 420 magnitude and phase information may include conducting an FFT operation on each of the baseband signals to provide magnitude and phase information as a function of range (i.e., a return signal magnitude and phase for each range bin).

Determining 430 angle and distance information may include using the phase information for each range bin to estimate an angle and distance to a (possible) reflection point corresponding to the particular range bin. Detecting, filtering, and tracking 440 one or more potential targets may include associating magnitude peaks with a target, filtering out transient peaks, and tracking the movement of the remaining peaks/targets.

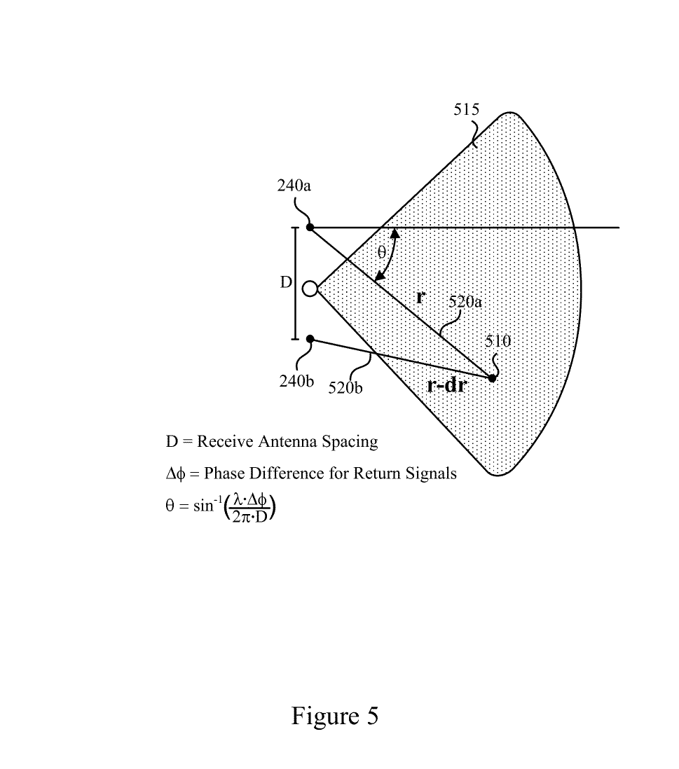

FIG. 5 is a graphical diagram depicting certain aspects of the return signal processing method of FIG. 4. Using standard geometric relationships, a relative position (r, θ) of a target 510 that is illuminated by a beam 515 emitted from a transmit antenna 230, may be calculated by knowing an offset distance D between the return antennas 240a and 240b along with a first distance 520a and a second distance 520b to the target 510. In some embodiments, the first distance 520a (i.e., r) and the second distance 520b (i.e., r−dr) to the target is calculated by resolving the distance range for a range bin corresponding to the target 510 to a specific measured distance using the phase information 262 (as a function of range bin) that is extracted from the return signals corresponding to the return antennas 240a and 240b. Subsequently, a phase difference Δφ between the return signals (for a range bin corresponding to the target 510) may be used to calculate the angle θ using the formula shown in FIG. 5.

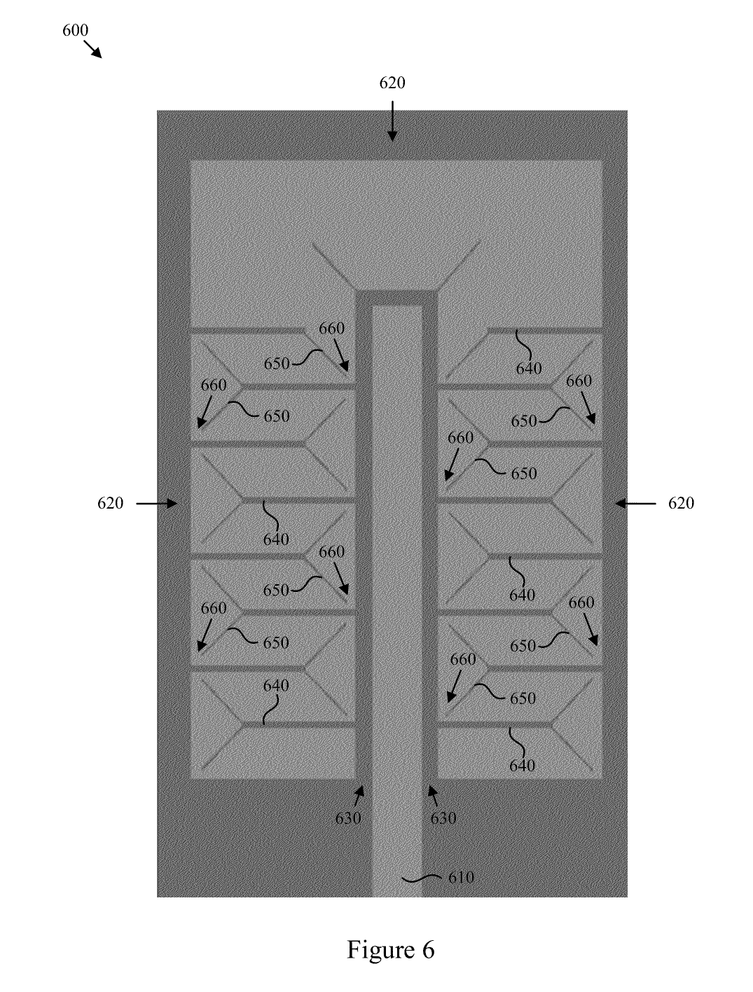

FIG. 6 is a front view of one embodiment of a planar antenna 600. The depicted planar antenna 600 includes a variety of features that increase the capacitance and inductance of the antenna and thereby reduce the footprint required for efficient operation and coverage at a selected operational frequency. For example, a feed trace 610 is provided that penetrates into a meander structure 620 and is separated therefrom by a gap 630 that increases the capacitance of the antenna. In the depicted embodiment, the meander structure 620 is serpentine and is formed by a number of horizontal (i.e., meander forming) slits 640. Inductance is added to the antenna with a number of diagonal (i.e., current concentrating) slits 650 within the meander structure 620 that creates a number of pinched regions 660 of high current density.

The slits 640 and slits 650 partition the meander structure 620 into a plurality of patches including triangular patches and parallelogram patches. Finally, the overall length of the antenna is shortened further by grounding it at the far (i.e., top) end to increase the effective electrical length of the antenna by a factor of approximately 2. Consequently, the planar antenna 600 provides significant advantages over standard prior art patch antennas.

In should be noted that many of the functional units described in this specification have been labeled as modules. Others are assumed to be modules. Modules may be embodied as hardware devices and/or digital processing units with executable instructions such as software or firmware. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference to a computer program product or computer-readable medium may take any non-transitory form capable of causing execution of a program of machine-readable instructions on a digital processing apparatus. For example, a computer-readable medium may be embodied by a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for determining location information for a target, the apparatus comprising:
a signal generation module configured to generate a cyclic transmit signal having a fixed frequency slope over a substantial portion of each cycle and an operational frequency that is selected to penetrate foliage;
at least one transmit antenna configured to generate electromagnetic radiation corresponding to the cyclic transmit signal without up-conversion of the cyclic transmit signal;
a down-conversion module configured to down-convert a plurality of return signals received from a corresponding plurality of return antennas with the cyclic transmit signal to provide a corresponding plurality of baseband signals;
a magnitude and phase extraction module configured to receive the plurality of baseband signals and provide magnitude and phase information for each return signal as a function of range;
a target location module configured to determine a location of a target from the magnitude and phase information.

2. The apparatus of claim 1, wherein the operational frequency is less than 1 GHz.

3. The apparatus of claim 1, wherein the fixed frequency slope varies less than 20 milli-radians over an operating period of 5 seconds.

4. The apparatus of claim 1, further comprising a target detection module configured to detect potential targets from the magnitude and phase information.

5. The apparatus of claim 4, further comprising a clutter filter configured to remove targets that are not substantially stationary.

6. The apparatus of claim 1, wherein the at least one transmit antenna is configured to provide a beam width of approximately 180 degrees.

7. The apparatus of claim 1, wherein the at least one transmit antenna comprises a planar antenna.

8. The apparatus of claim 1, wherein the planar antenna comprises a feed line encompassed by a meander structure comprising a plurality of patches.

9. The apparatus of claim 8, wherein the meander structure comprises a plurality of meander forming slits.

10. The apparatus of claim 8, wherein the meander structure comprises a plurality of current concentrating slits.

11. The apparatus of claim 8, wherein the meander structure is grounded on a distal edge that is perpendicular to the feed line.

12. A method for determining location information for a target, the method comprising:
generating a cyclic transmit signal having a fixed frequency slope over a substantial portion of each cycle and an operational frequency that is selected to penetrate foliage;
transmitting the cyclic transmit signal without up-conversion with at least one transmit antenna;
down-converting a plurality of return signals received from a corresponding plurality of return antennas with the cyclic transmit signal to provide a corresponding plurality of baseband signals;
extracting magnitude and phase information for each return signal as a function of range from the plurality of baseband signals; and
determining a location of a target from the magnitude and phase information.

13. The method of claim 12, wherein the operational frequency is less than 1 GHz.

14. The method of claim 12, wherein the fixed frequency slope varies less than 20 milli-radians over an operating period of 5 seconds.

15. The method of claim 12, further comprising detecting potential targets from the magnitude and phase information.

16. The method of claim 15, further comprising a filtering the potential targets to remove targets that are not substantially stationary.

17. A computer readable medium comprising computer readable program codes configured to conduct a method for determining location information for a target, the method comprising:
generating a cyclic transmit signal having a fixed frequency slope over a substantial portion of each cycle and an operational frequency that is selected to penetrate foliage;
transmitting the cyclic transmit signal without up-conversion with at least one transmit antenna;
down-converting a plurality of return signals received from a corresponding plurality of return antennas with the cyclic transmit signal to provide a corresponding plurality of baseband signals;
extracting magnitude and phase information for each return signal as a function of range from the plurality of baseband signals; and
determining a location of a target from the magnitude and phase information.

18. The computer readable medium of claim 17, wherein the operational frequency is less than 1 GHz.

19. The computer readable medium of claim 17, wherein the fixed frequency slope varies less than 20 milli-radians over an operating period of 5 seconds.

20. The computer readable medium of claim 17, further comprising detecting potential targets from the magnitude and phase information.
